(19) United States
(12) Patent Application Publication
(10) Pub. No.: US 2026/0043898 A1
(43) Pub. Date: Feb. 12, 2026

(54) RADIO WAVE SENSOR SETTING METHOD, SETTING DEVICE, AND COMPUTER PROGRAM

(71) Applicant: Sumitomo Electric Industries, Ltd., Osaka-shi, Osaka (JP)

(72) Inventor: Hiroki KATO, Osaka-shi, Osaka (JP)

(73) Assignee: Sumitomo Electric Industries, Ltd., Osaka-shi, Osaka (JP)

(21) Appl. No.: 19/100,582

(22) PCT Filed: Jun. 1, 2023
(86) PCT No.: PCT/JP2023/020514

§ 371 Date: Feb. 3, 2025

(30) Foreign Application Priority Data
Aug. 9, 2022 (JP) 2022-126892

(51) Int. Cl. G01S 7/295; G01S 13/91

(52) U.S. Cl. CPC G01S 7/2955; G01S 13/91

(57) ABSTRACT

A radio wave sensor setting method for setting, in a radio wave sensor, a detection area determined on a road includes: acquiring coordinate values, in a latitude-longitude coordinate system, of each of a plurality of definition points that define the detection area; transforming the coordinate values of each of the plurality of definition points in the latitude-longitude coordinate system, to coordinate values in a unique coordinate system that is used in the radio wave sensor; and setting the detection area in the radio wave sensor, based on the coordinate values of each of the plurality of definition points in the unique coordinate system.

### TECHNICAL FIELD

The present disclosure relates to a radio wave sensor setting method, a setting device, and a computer program. This application claims priority on Japanese Patent Application No. 2022-126892 filed on Aug. 9, 2022, the entire content of which is incorporated herein by reference.

### BACKGROUND ART

A radio wave sensor is installed at a position on a road or an intersection where objects such as a vehicle and a pedestrian can be detected, for the purpose of traffic monitoring. Such a radio wave sensor as an infrastructure (road equipment) is used, for example, to measure traffic volume of vehicles traveling on a road or to detect a pedestrian on a crosswalk. In order to use the radio wave sensor for the purpose of traffic monitoring, a detection-target area (hereinafter, referred to as “detection area”) on a roadway, a traffic lane, a crosswalk, a sidewalk, etc. need to be set in a coordinate system of the radio wave sensor.

When the detection area is set in the radio wave sensor, a reference object is used in some cases. For example, the reference object is placed at a position at which an area (e.g., crosswalk) to be set as the detection area can be specified, and the radio wave sensor detects the reference object, whereby the detection area is set. However, many objects other than the reference object, for example, a vehicle, a pedestrian, etc. are present on a roadway, a crosswalk, a sidewalk, etc. Thus, even if a reflected wave from the reference object is detected in the radio-wave area, the reflected wave from the reference object and a reflected wave (noise) from an object other than the reference object cannot be distinguished from each other in some cases.

PATENT LITERATURE 1 discloses a method in which, while a reference object having a reflection unit is moved, a radio wave sensor transmits a radio wave to the reference object, and receives a reflected wave which is the wave reflected by the reflection unit, and the reflected wave by the reflection unit and noise are distinguished from each other using time variation generated in detection data obtained from the reflected wave.

### CITATION LIST

### Patent Literature

PATENT LITERATURE 1: International Publication No. WO 2021/181981

### SUMMARY OF THE INVENTION

A radio wave sensor setting method according to an embodiment of the present disclosure is a method for setting, in a radio wave sensor, a detection area determined on a road, and includes: acquiring coordinate values, in a latitude-longitude coordinate system, of each of a plurality of definition points that define the detection area; transforming the coordinate values of each of the plurality of definition points in the latitude-longitude coordinate system, to coordinate values in a unique coordinate system that is used in the radio wave sensor; and setting the detection area in the radio wave sensor, based on the coordinate values of each of the plurality of definition points in the unique coordinate system.

### BRIEF DESCRIPTION OF DRAWINGS

FIG. 1 shows a usage example of a radio wave sensor according to an embodiment.

FIG. 2 is a block diagram showing an example of a hardware configuration of a setting device according to the embodiment.

FIG. 3 is a functional block diagram showing an example of functions of the setting device according to the embodiment.

FIG. 4 illustrates an example of setting a detection area.

FIG. 5 illustrates an example of correcting a measured value of a distance to a specific point.

FIG. 6 illustrates an example of generating a transformation equation.

FIG. 7 is a flowchart showing an example of a procedure of a setting operation of the detection area.

FIG. 8 is a flowchart showing an example of a transformation equation generation process.

FIG. 9 is a flowchart showing an example of a detection area setting process.

### DETAILED DESCRIPTION

### Problems to be Solved by the Present Disclosure

In the method disclosed in PATENT LITERATURE 1, when the number of positions detected to set the detection area is increased, the reference object needs to be moved to each position. Further, detection data which is redundant and includes time variation for each detected position needs to be acquired. Therefore, much effort and time are required for setting of the radio wave sensor.

### Effect of the Present Disclosure

According to the present disclosure, the effort and time required for setting of the radio wave sensor can be reduced.

### Outline of Embodiment of the Present Disclosure

Hereinafter, the outline of an embodiment of the present disclosure is listed and described.

(1) A radio wave sensor setting method according to the present embodiment is a radio wave sensor setting method for setting, in a radio wave sensor, a detection area determined on a road, and includes: acquiring coordinate values, in a latitude-longitude coordinate system, of each of a plurality of definition points that define the detection area; transforming the coordinate values of each of the plurality of definition points in the latitude-longitude coordinate system, to coordinate values in a unique coordinate system that is used in the radio wave sensor; and setting the detection area in the radio wave sensor, based on the coordinate values of each of the plurality of definition points in the unique coordinate system. Accordingly, the coordinate values in the latitude-longitude coordinate system, which can be acquired without the radio wave sensor, are acquired, whereby the detection area can be set in the radio wave sensor. Therefore, the effort and time required for setting of the radio wave sensor can be reduced.

(2) In the above (1), the radio wave sensor setting method may further include generating a transformation equation for transforming coordinate values in the latitude-longitude coordinate system to coordinate values in the unique coordinate system, based on coordinate values of a plurality of points in the latitude-longitude coordinate system and coordinate values of the plurality of points in the unique coordinate system. Since such a transformation equation is generated for each radio wave sensor, the detection area can be correctly set in the radio wave sensor.

(3) In the above (2), the plurality of points used to generate the transformation equation may be different from the plurality of definition points. Accordingly, the transformation equation can be generated using points suitable for generating the transformation equation.

(4) In the above (2) or (3), the plurality of points used to generate the transformation equation may include an origin in the unique coordinate system. Accordingly, the transformation equation can be generated easily.

(5) In the above (4), the plurality of points used to generate the transformation equation may further include a point on a coordinate axis, other than the origin, in the unique coordinate system. Accordingly, the transformation equation can be generated more easily.

(6) In the above (5), the coordinate axis may extend along a reference line that is a line of intersection of the ground and a vertical plane including a radio-wave irradiation axis of the radio wave sensor. Accordingly, one point used to generate the transformation equation is a point in front of the radio wave sensor, and thus such a point can be determined easily.

(7) In any one of the above (2) to (6), the radio wave sensor setting method may further include: acquiring the coordinate values, in the latitude-longitude coordinate system, of the plurality of points used to generate the transformation equation; and acquiring the coordinate values, in the unique coordinate system, of the plurality of points used to generate the transformation equation through detection, by the radio wave sensor, of a reference object placed at each of the plurality of points used to generate the transformation equation. Since the reference object is detected by the radio wave sensor, the coordinate values in the unique coordinate system used to generate the transformation equation are acquired.

(8) In the above (7), in acquiring the coordinate values in the unique coordinate system, the coordinate values, in the unique coordinate system, of the plurality of points used to generate the transformation equation may be acquired by correcting, based on a height of the radio wave sensor from the ground, a measured value of a distance to the reference object by the radio wave sensor. Accordingly, correct coordinate values in the unique coordinate system used to generate the transformation equation can be acquired.

(9) In the above (7) or (8), in acquiring the coordinate values in the latitude-longitude coordinate system, before the radio wave sensor is activated, the coordinate values, in the latitude-longitude coordinate system, of the plurality of points used to generate the transformation equation may be acquired. Accordingly, the effort for setting of the radio wave sensor can be reduced.

(10) A setting device according to the present embodiment is a setting device for setting, in a radio wave sensor, a detection area determined on a road, and includes: an input unit configured to receive coordinate values, in a latitude-longitude coordinate system, of each of a plurality of definition points that define the detection area; a transformation unit configured to transform the coordinate values of each of the plurality of definition points in the latitude-longitude coordinate system, to coordinate values in a unique coordinate system that is used in the radio wave sensor; and a setting unit configured to set the detection area in the radio wave sensor, based on the coordinate values of each of the plurality of definition points in the unique coordinate system. Accordingly, the coordinate values in the latitude-longitude coordinate system, which can be acquired without the radio wave sensor, are acquired, whereby the detection area can be set in the radio wave sensor. Therefore, the effort and time required for setting of the radio wave sensor can be reduced.

(11) A computer program according to the present embodiment is a computer program for setting, in a radio wave sensor, a detection area determined on a road, the computer program causing a computer to: acquire coordinate values, in a latitude-longitude coordinate system, of each of a plurality of definition points that define the detection area; transform the coordinate values of each of the plurality of definition points in the latitude-longitude coordinate system, to coordinate values in a unique coordinate system that is used in the radio wave sensor; and set the detection area in the radio wave sensor, based on the coordinate values of each of the plurality of definition points in the unique coordinate system. Accordingly, the coordinate values in the latitude-longitude coordinate system, which can be acquired without the radio wave sensor, are acquired, whereby the detection area can be set in the radio wave sensor. Therefore, the effort and time required for setting of the radio wave sensor can be reduced.

The present disclosure can be realized not only as a radio wave sensor setting method including the characteristic steps as described above, but also as a setting device having characteristic configurations or as a computer program that causes a computer to perform characteristic steps. The present disclosure can be realized as a setting system including the setting device, or a part or the entirety of the setting device can be realized as a semiconductor integrated circuit.

### Details of Embodiment of the Present Disclosure

Hereinafter, the embodiment of the present disclosure will be described in detail with reference to the drawings. At least some parts of the embodiment described below may be combined together as desired.

### [1. Radio Wave Sensor]

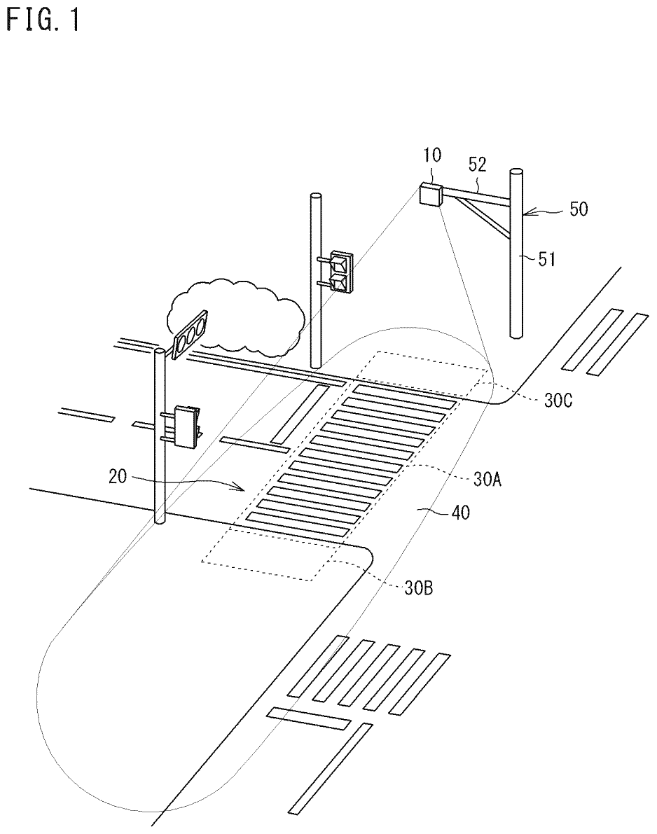

FIG. 1 shows a usage example of a radio wave sensor according to the embodiment. A radio wave sensor 10 according to the present embodiment is a radio wave radar for traffic monitoring, and detects a pedestrian on a crosswalk 20. The radio wave sensor 10 is, for example, a millimeter wave radar.

The radio wave sensor 10 is mounted to a structure 50 installed on a road. The structure 50 has a height of several meters, and the radio wave sensor 10 is installed at a height of several meters above the ground. The structure 50 includes, for example, a pole 51 and an arm 52 disposed near an upper end of the pole 51, and the radio wave sensor 10 is mounted to the arm 52.

The radio wave sensor 10 emits a radio wave (millimeter wave) onto a road, for example, a roadway, a traffic lane, a crosswalk, a sidewalk, etc., and receives the reflected wave to detect an object (a vehicle, a pedestrian, a bicycle, etc.) on the road. In the example shown in FIG. 1, the radio wave sensor 10 detects a pedestrian, a bicycle, etc. on the crosswalk 20. More specifically, the radio wave sensor 10 can detect the distance from the radio wave sensor 10 to the object on the crosswalk 20, the speed of the object, and the horizontal angle (azimuth angle) of the position where the object is present, with respect to the radio-wave irradiation axis.

In the radio wave sensor 10, detection areas 30A, 30B, 30C, which are each a range on the road for detecting an object, are set. Each of the detection areas 30A, 30B, 30C is set as a part of a radio-wave irradiation range 40 of the radio wave sensor 10. That is, the radio-wave irradiation range 40 covers the detection areas 30A, 30B, 30C. In order for the radio wave sensor 10 to monitor the traffic condition of the entire crosswalk 20, it is preferable to set the detection areas 30A, 30B, 30C that include the entire crosswalk 20. The radio-wave irradiation range 40 is a range in which the object reflects the radio wave emitted from the radio wave sensor 10, and the reflected wave from the object enables the radio wave sensor 10 to detect the object. The radio-wave irradiation range 40 does not include a range in which the radio wave sensor 10 cannot detect an object even though the range can be irradiated with the radio wave. However, the radio-wave irradiation range 40 is not limited thereto, and may be the entirety of the range that can be irradiated with the radio wave by the radio wave sensor 10.

The detection area 30A is an area including the crosswalk 20. The detection areas 30B, 30C are each an area including a waiting area where a pedestrian waits at a traffic signal on a sidewalk before crossing the crosswalk 20. The detection area 30B is provided at a position closer to the radio wave sensor 10 than the detection area 30A, and the detection area 30C is provided at a position farther from the radio wave sensor 10 than the detection area 30A.

The detection areas 30A, 30B, 30C are examples of detection areas, and the detection areas are not limited thereto. For example, the detection area may be set on a roadway provided with no crosswalk, or the detection area may be set on each traffic lane.

If the detection areas 30A, 30B, 30C are not correctly set, the above-described radio wave sensor 10 cannot correctly detect a pedestrian crossing the crosswalk 20 or a pedestrian waiting at a traffic signal in a waiting area. Thus, the detection areas 30A, 30B, 30C need to be correctly set in the radio wave sensor 10. In the present embodiment, an operator sets the detection areas 30A, 30B, 30C in the above-described radio wave sensor 10 by using a setting device.

### [2. Configuration of Setting Device]

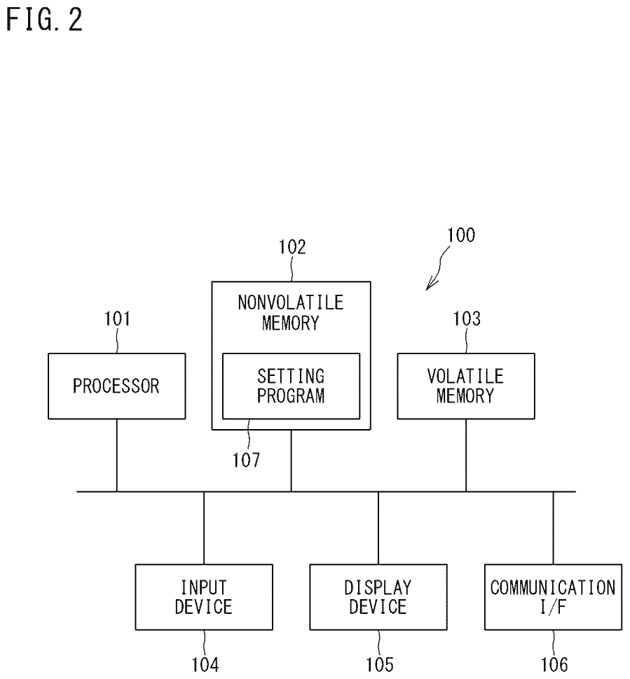

FIG. 2 is a block diagram showing an example of a hardware configuration of the setting device according to the present embodiment. A setting device 100 according to the present embodiment is used by the operator (user) who sets the detection areas in the radio wave sensor 10. The setting device 100 includes a processor 101, a nonvolatile memory 102, a volatile memory 103, an input device 104, a display device 105, and a communication interface (communication I/F) 106.

The volatile memory 103 is, for example, a semiconductor memory such as an SRAM (Static Random Access Memory) or a DRAM (Dynamic Random Access Memory). The nonvolatile memory 102 is, for example, a flash memory, a hard disk, a ROM (Read Only Memory), or the like. The nonvolatile memory 102 has, stored therein, a setting program 107 as a computer program, and data used for execution of the setting program 107. Each of the functions of the setting device 100 is exhibited when the setting program 107 as the computer program stored in a storage device of the computer is executed by the processor 101. The setting program 107 can be stored in a recording medium such as a flash memory, a ROM, or a CD-ROM. The processor 101 sets a detection area in the radio wave sensor 10 according to the setting program 107.

The processor 101 is, for example, a CPU (Central Processing Unit). However, the processor 101 is not limited to a CPU. The processor 101 may be a GPU (Graphics Processing Unit). The processor 101 is, for example, a multicore processor. The processor 101 may be a single core processor. For example, the processor 101 may be an ASIC (Application Specific Integrated Circuit), or may be a programmable logic device such as a gate array or an FPGA (Field Programmable Gate Array). In this case, the ASIC or the programmable logic device is configured to be able to execute the same processing as the setting program 107.

For example, the input device 104 includes a keyboard and a pointing device such as a mouse. The input device 104 may be a capacitive or pressure sensitive touchpad that is overlaid on the screen of the display device 105. The input device 104 is used to input data to the setting device 100.

The display device 105 includes, for example, a liquid crystal panel or an OEL (organic electroluminescence) panel. The display device 105 can display textual or graphic information.

The communication I/F 106 can communicate with the radio wave sensor 10. The communication I/F 106 is, for example, a wired communication interface, and is connected to the radio wave sensor 10 via a signal line. The communication I/F 106 may be a wireless communication interface. For example, the communication I/F 106 can receive a detection result regarding an object (information on the position of the detected object) from the radio wave sensor 10, and can transmit setting data for a detection area, which has been determined by using the setting device 100, to the radio wave sensor 10.

### [3. Function of Setting Device]

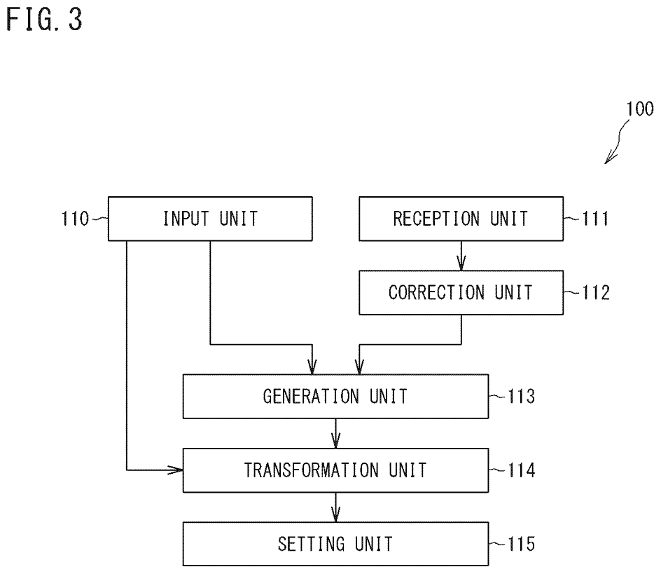

FIG. 3 is a functional block diagram showing an example of functions of the setting device according to the present embodiment. The processor 101 executing the setting program 107 allows the setting device 100 to function as an input unit 110, a reception unit 111, a correction unit 112, a generation unit 113, a transformation unit 114, and a setting unit 115.

The input unit 110 is mainly implemented by the input device 104. The reception unit 111 is mainly implemented by the communication I/F 106. The correction unit 112, the generation unit 113, the transformation unit 114, and the setting unit 115 are mainly implemented by the processor 101.

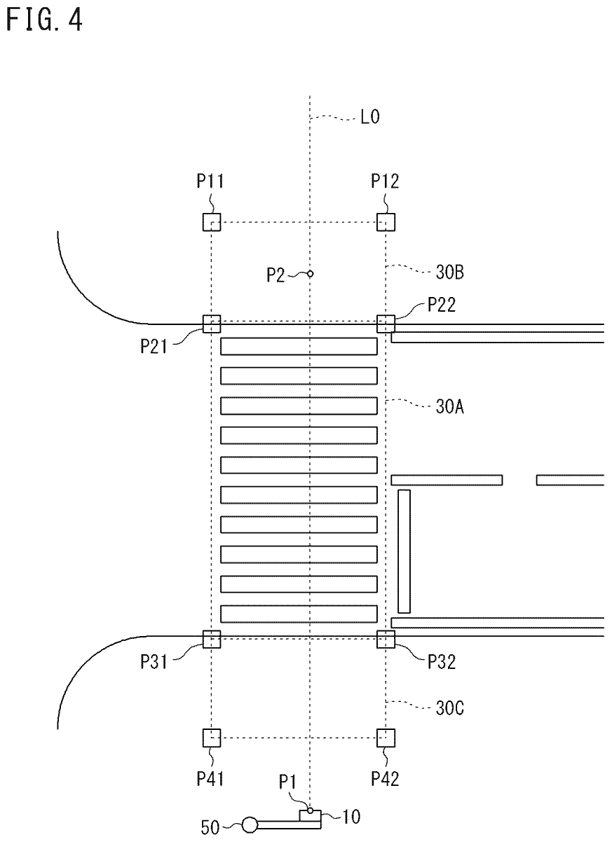

FIG. 4 illustrates an example of setting a detection area. Before or after the radio wave sensor 10 is mounted to the structure 50, the user determines a plurality of specific points P1, P2 which are used to generate a transformation equation for transforming coordinate values in a latitude-longitude coordinate system (hereinafter, referred to as “latitude-longitude coordinate values”) to coordinate values in a unique coordinate system (hereinafter, referred to as “unique coordinate values”) of the radio wave sensor 10. The number of the specific points is, for example, two.

The specific points P1, P2 are points on the ground, and are points included in the radio-wave irradiation range 40. For example, the specific point P1 is a point vertically below the radio wave sensor 10. For example, the specific point P2 is a point in front of the radio wave sensor 10. More specifically, the specific point P2 is a point on a line of intersection (hereinafter, referred to as “reference line”) L0 between the ground and a vertical plane including a radio-wave irradiation axis of the radio wave sensor 10 (a direction normal to a radio-wave irradiation surface of the radio wave sensor 10). However, the specific points P1, P2 are not limited to these points, and may be the two points included in the radio-wave irradiation range 40.

The user measures the latitude-longitude coordinate values of the specific points P1, P2 by using a GNSS (Global Navigation Satellite System) receiver which is not shown. The measurement of the latitude-longitude coordinate values of the specific points P1, P2 is performed before the radio wave sensor 10 is energized and activated, for example.

Referring back to FIG. 3, the user inputs the measured latitude-longitude coordinate values of the specific points P1, P2 to the setting device 100. The input unit 110 receives the latitude-longitude coordinate values of the specific points P1, P2.

The unique coordinate system is a coordinate system that is used in the radio wave sensor 10, and is a coordinate system unique to the radio wave sensor 10. For example, the unique coordinate system is an orthogonal coordinate system having a point vertically below the radio wave sensor 10 as the origin, the reference line L0 as a first coordinate axis (y-axis), and a horizontal axis orthogonal to the reference line L0, as a second coordinate axis (x-axis). That is, in this case, the y-axis of the unique coordinate system extends along the reference line L0. In a case where the specific point P1 is the point vertically under the radio wave sensor 10, the specific point P1 is the origin of the unique coordinate system. In a case where the specific point P2 is the point in front of the radio wave sensor 10, the specific point P2 is a point on the y-axis of the unique coordinate system.

The user acquires the unique coordinate values of the specific points P1, P2. Specifically, the user places a reference object at the specific point P2, and measures the unique coordinate values of the reference object by the radio wave sensor 10. The radio wave sensor 10 detects the reference object, and measures the position (distance and azimuth angle) of the reference object, that is, the unique coordinate values. The radio wave sensor 10 transmits the measured unique coordinate values of the specific point P2. The reception unit 111 receives the unique coordinate values of the specific point P2.

In a case where the specific point P1 is the origin of the unique coordinate system, the unique coordinate values of the specific point Pl need not be measured by the radio wave sensor 10. In this case, the unique coordinate values of the specific point P1 are set in advance. For example, the unique coordinate values of the specific point P1 are stored in the nonvolatile memory 102 in advance, and the setting device 100 reads out the unique coordinate values of the specific point P1 from the nonvolatile memory 102, whereby the unique coordinate values of the specific point P1 can be acquired. In a case where the specific point Pl is a point other than the origin of the unique coordinate system, the user places a reference object at the specific point P1, and measures the position of the reference object by the radio wave sensor 10, whereby the unique coordinate values of the specific point P1 are acquired. In this case, the radio wave sensor 10 transmits the unique coordinate values of the specific point P1, and the reception unit 111 receives the unique coordinate values of the specific point P1.

The correction unit 112 corrects a measured value of a distance to the reference object by the radio wave sensor 10, based on a height of the radio wave sensor 10 from the ground (hereinafter, referred to as “installation height”), whereby the unique coordinate values of the specific points P1, P2 are acquired. Specifically, the correction unit 112 corrects the unique coordinate values of the specific point P2, based on the installation height of the radio wave sensor 10.

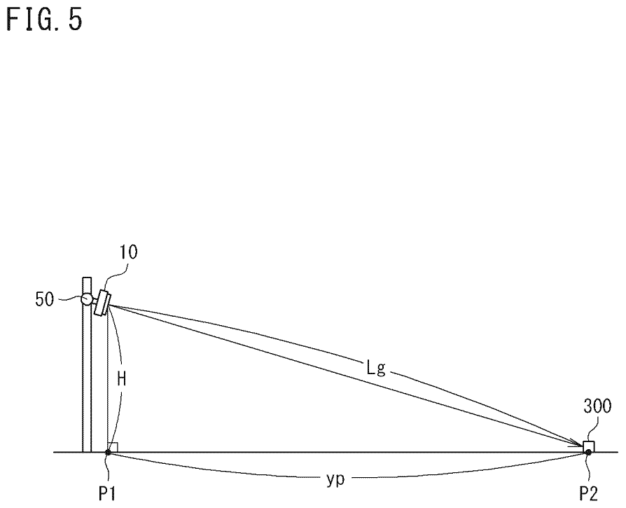

FIG. 5 illustrates an example of correcting a measured value of a distance to the specific point. The radio wave sensor 10 detects a reference object 300 placed at the specific point P2, and measures a distance Lg to the reference object 300. Here, for simplifying the description, it is assumed that the specific point P2 is on the reference line L0, that is, on the y-axis. In this case, the radio wave sensor 10 measures the unique coordinate values of the specific point P2 as (0, Lg). However, the unique coordinate values (0, Lg) of the specific point P2 outputted from the radio wave sensor 10 include an error due to an installation height H of the radio wave sensor 10. That is, a distance yp between the specific points P1, P2 and the distance Lg between the radio wave sensor 10 and the specific point P2 are different from each other.

The correction unit 112 corrects the unique coordinate values of the specific point P2 using the Pythagorean theorem. Specifically, in a right triangle formed by the radio wave sensor 10, the specific point P1, and the specific point P2, Lg²-yp²+H² is satisfied. The correction unit 112 calculates the distance yp from the distance Lg and the installation height H, using this relationship. With the correction unit 112, the correct unique coordinate values (0, yp) of the specific point P2 can be acquired.

The correction unit 112 may not necessarily correct the unique coordinate values of the specific point P2. For example, in a case where the specific point P2 is sufficiently away from the radio wave sensor 10, the distance Lg between the radio wave sensor 10 and the specific point P2 is a value close to the distance yg between the specific point P1 and the specific point P2, so that an error may be ignored. In such a case, the correction unit 112 may be omitted.

Referring back to FIG. 3, the generation unit 113 generates a transformation equation for transforming the latitude-longitude coordinate values to the unique coordinate values, based on the latitude-longitude coordinate values of the specific points P1, P2 and the unique coordinate values of the specific points P1, P2.

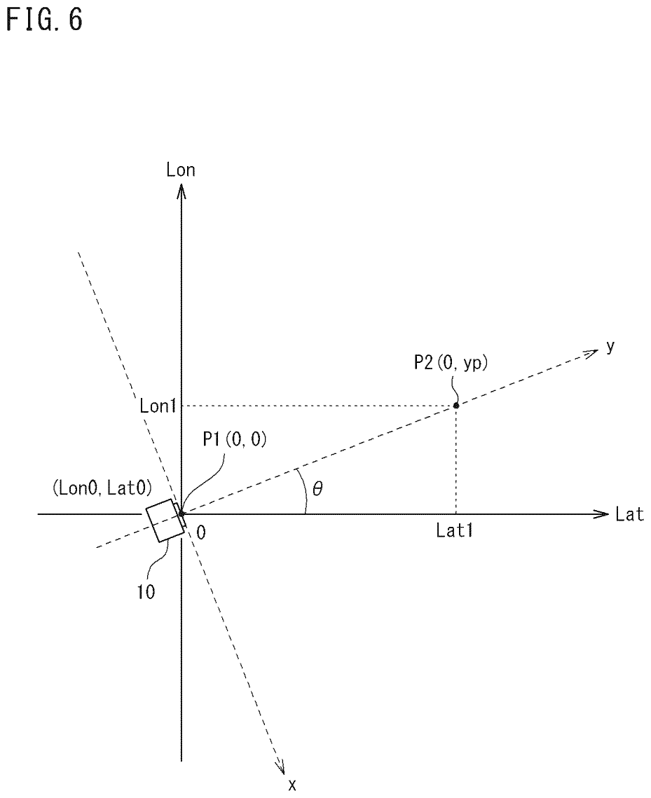

Hereinafter, an example of generating the transformation equation will be specifically described. FIG. 6 illustrates an example of generating the transformation equation. In FIG. 6, coordinate axes Lon, Lat of the latitude-longitude coordinate system are indicated by solid lines, and coordinate axes x, y of the unique coordinate system are indicated by broken lines. The coordinate axis Lon is a longitude coordinate axis, and the coordinate axis Lat is a latitude coordinate axis. θ is a deviation angle of the unique coordinate system with respect to the latitude-longitude coordinate system. The latitude-longitude coordinate values of the specific point P1 are (Lon0, Lat0), and the latitude-longitude coordinate values of the specific point P2 are (Lon1, Lat1).

The transformation equation is defined by equation (1).

$$[ Math . 1 ]$$

$$\begin{matrix}( \begin{matrix}x \\ y\end{matrix} ) & = ( \begin{matrix}cos θ & sin θ \\ - sin θ & cos θ\end{matrix} ) ( \begin{matrix}X \\ Y\end{matrix} ) \\ X & = ( Lon - Lon 0 ) \times L 1 \\ Y & = ( Lat - Lat 0 ) \times L 2\end{matrix} \} \qquad ( 1 )$$

The generation unit 113 generates the transformation equation by determining parameters θ, L1, L2 in equation (1).

The specific point P2 is set approximately in front of the radio wave sensor 10, but, in some cases, the specific point P2 is set outside of the reference line LO due to a deviation in the angle at which the radio wave sensor 10 is installed, deviation in the position at which the specific point P2 is set, or the like. The generation unit 113 determines a deviation amount DB of the specific point P2 from the reference line L0, based on the unique coordinate values of the specific point P2.

A distance L1 per degree of latitude and a distance L2 per degree of longitude vary depending on the location on Earth. Thus, the generation unit 113 calculates L1, L2 with respect to the installed position of the radio wave sensor 10 in a plane-rectangular coordinate system. For example, the generation unit 113 acquires the coordinate values of a point (Lon0+1, Lat0) and the coordinate values of a point (Lon0, Lat0+1) in the plane-rectangular coordinate system having the latitude-longitude coordinate values (Lon0, Lat0) of the specific point P1 as the origin, to calculate L1, L2. The plane-rectangular coordinate system is a coordinate system in which a curved surface of the Earth is projected on a plane.

The generation unit 113 calculates a difference (x_diff, y_diff) between the coordinate values of the specific point Pl and the coordinate values of the specific point P2 in the plane-rectangular coordinate system. The generation unit 113 determines θ from equation (2).

$$[ Math . 2 ]$$

$$θ = atan ( \frac{y \_ diff}{x \_ diff} ) + DB \qquad ( 2 )$$

As described above, the transformation equation is generated.

FIG. 4 is referred to. Before or after the radio wave sensor 10 is mounted to the structure 50, the user determines definition points P11, P12, P21, P22, P31, P32, P41, P42 for defining the detection areas 30A, 30B, 30C, and measures the latitude-longitude coordinate values of the definition points P11, P12, P21, P22, P31, P32, P41, P42 by using the GNSS receiver. The user may measure the latitude-longitude coordinate values of the definition points P11, P12, P21, P22, P31, P32, P41, P42 while measuring the latitude-longitude coordinate values of the specific points P1, P2, or may measure the latitude-longitude coordinate values of the definition points P11, P12, P21, P22, P31, P32, P41, P42, after measuring the latitude-longitude coordinate values of the specific points P1, P2, for example, after generation of the transformation equation. Measurement of the latitude-longitude coordinate values of the definition points P11, P12, P21, P22, P31, P32, P41, P42 is performed, for example, before the radio wave sensor 10 is energized and activated. For example, as shown in FIG. 4, all of the definition points P11, P12, P21, P22, P31, P32, P41, P42 may be different from the specific points P1, P2. For example, two of the definition points P11, P12, P21, P22, P31, P32, P41, P42 may be the specific points P1, P2.

Referring back to FIG. 3, the user inputs the measured latitude-longitude coordinate values of the definition points P11, P12, P21, P22, P31, P32, P41, P42, to the setting device 100. The input unit 110 receives the latitude-longitude coordinate values of the definition points P11, P12, P21, P22, P31, P32, P41, P42.

The transformation unit 114 transforms the latitude-longitude coordinate values of each of the definition points P11, P12, P21, P22, P31, P32, P41, P42, to unique coordinate values. That is, the transformation unit 114 assigns the latitude-longitude coordinate values of each of the definition points P11, P12, P21, P22, P31, P32, P41, P42, to Lon, Lat of the transformation equation, to calculate the unique coordinate values (x, y).

The setting unit 115 sets the detection areas 30A, 30B, 30C in the radio wave sensor, based on the unique coordinate values of each of the definition points P11, P12, P21, P22, P31, P32, P41, P42. Specifically, the setting unit 115 generates setting data for setting the detection areas 30A, 30B, 30C, and transmits the generated setting data to the radio wave sensor 10. The setting data includes the unique coordinate values of each of the definition points P11, P12, P21, P22, P31, P32, P41, P42. The radio wave sensor 10 receives the setting data, and sets the detection areas 30A, 30B, 30C, based on the setting data.

### [4. Setting Operation of Detection Area]

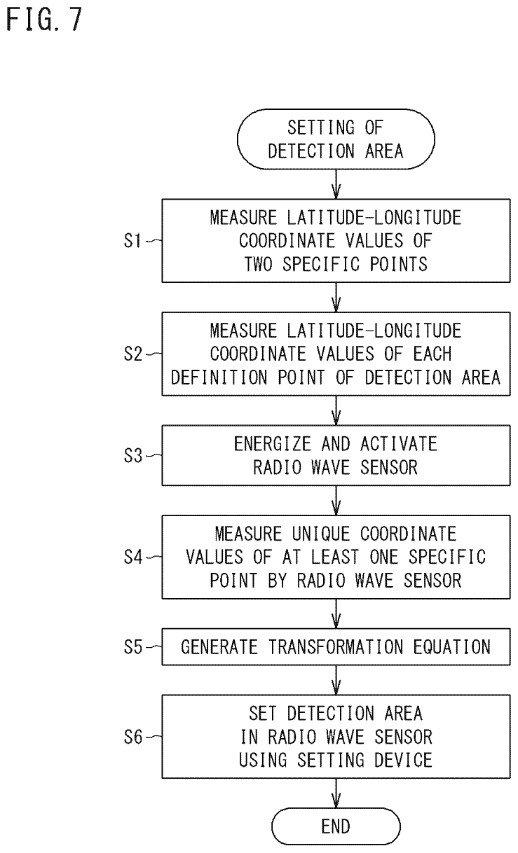

Hereinafter, a setting operation of the detection areas by using the setting device 100 will be described. FIG. 7 is a flowchart showing an example of a procedure of the setting operation of the detection areas.

Before the radio wave sensor 10 is energized and activated, the user determines two specific points P1, P2, and measures the latitude-longitude coordinate values of the specific points P1, P2 by using the GNSS receiver (step S1). Further, before the radio wave sensor 10 is energized and activated, the user determines the definition points P11, P12, P21, P22, P31, P32, P41, P42, and measures the latitude-longitude coordinate values of the definition points P11, P12, P21, P22, P31, P32, P41, P42 by using the GNSS receiver (step S2).

The user energizes and activates the radio wave sensor 10 (step S3). Accordingly, the radio wave sensor 10 is ready to detect an object.

The user places the reference object 300 on at least the specific point P2, of the specific points P1, P2, and causes the radio wave sensor 10 to detect the reference object. The radio wave sensor 10 detects the reference object 300, and measures the unique coordinate values of the reference object (i.e., specific point P2) (step S4). If the specific point P1 is the origin of the unique coordinate system (directly under the radio wave sensor 10), the unique coordinate values of the specific point P1 need not be measured. However, if the specific point P1 is a point other than the origin of the unique coordinate system, the user places the reference object 300 at the specific point P1, and also measures the unique coordinate values of the specific point P1 by using the radio wave sensor 10.

The user connects the setting device 100 to the radio wave sensor 10. The setting device 100 generates a transformation equation for performing coordinate transformation between latitude-longitude coordinate values and unique coordinate values (step S5).

The user inputs the latitude-longitude coordinate values of the definition points P11, P12, P21, P22, P31, P32, P41, P42, to the setting device 100. The setting device 100 transforms the latitude-longitude coordinate values of the definition points P11, P12, P21, P22, P31, P32, P41, P42 to unique coordinate values, and sets the detection areas 30A, 30B, 30C in the radio wave sensor 10 (step S6). This is the end of the setting operation of the detection areas.

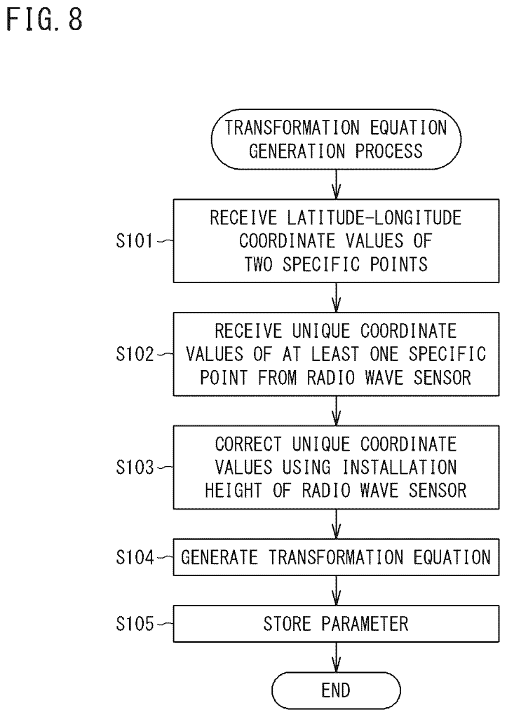

The setting device 100 performs a transformation equation generation process in step S5. FIG. 8 is a flowchart showing an example of the transformation equation generation process.

The user inputs the latitude-longitude coordinate values of the specific points P1, P2, which have been measured by the GNSS receiver, to the setting device 100. The processor 101 of the setting device 100 receives the inputted latitude-longitude coordinate values of the specific points P1, P2 (step S101).

The unique coordinate values of at least the specific point P2 are transmitted from the radio wave sensor 10. The setting device 100 receives at least the unique coordinate values of the specific point P2 (step S102). If the specific point P1 is set as the origin in the unique coordinate system, the processor 101 reads out the unique coordinate values of the specific point P1 from the nonvolatile memory 102, for example. For example, if the origin is defined as the unique coordinate values of the specific point P1 in the setting program 107, the processor 101 need not read out the unique coordinate values of the specific point P1 from the nonvolatile memory 102.

The processor 101 corrects the unique coordinate values of the specific point P2 using the installation height H of the radio wave sensor 10 (step S103).

The processor 101 generates the transformation equation, based on the latitude-longitude coordinate values of the specific points P1, P2 and the unique coordinate values of the specific points P1, P2 (step S104). Specifically, the processor 101 determines the above-described parameters θ, L1, L2.

The processor 101 stores the determined parameters θ, L1, L2 into the nonvolatile memory 102, to store the transformation equation (step S105). This is the end of the transformation equation generation process.

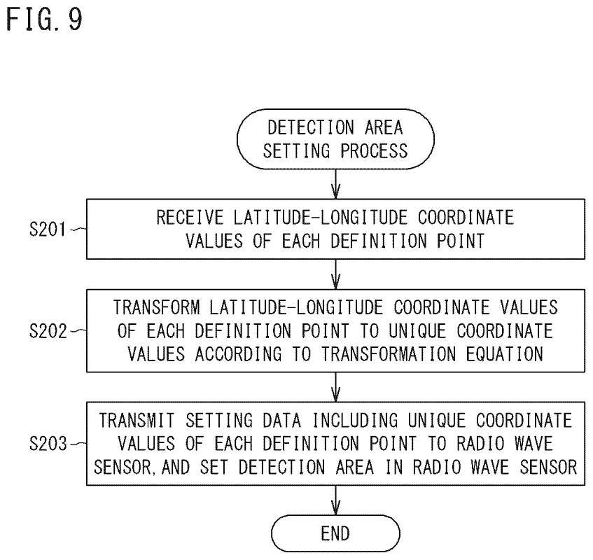

The setting device 100 performs a detection area setting process in step S6. FIG. 9 is a flowchart showing an example of the detection area setting process.

The user inputs the latitude-longitude coordinate values of the definition points P11, P12, P21, P22, P31, P32, P41, P42, which have been measured by the GNSS receiver, to the setting device 100. The processor 101 of the setting device 100 receives the inputted latitude-longitude coordinate values of the definition points P11, P12, P21, P22, P31, P32, P41, P42 (step S201).

The processor 101 transforms the latitude-longitude coordinate values of the definition points P11, P12, P21, P22, P31, P32, P41, P42 to unique coordinate values according to the transformation equation (step S202).

The processor 101 generates the setting data including the unique coordinate values of the definition points P11, P12, P21, P22, P31, P32, P41, P42. The processor 101 transmits the generated setting data to the radio wave sensor 10, and sets the detection areas 30A, 30B, 30C in the radio wave sensor 10 (step S203). This is the end of the detection area setting process.

### [5. Modification]

In the above-described embodiment, transformation from the latitude-longitude coordinate values of the definition points P11, P12, P21, P22, P31, P32, P41, P42 to unique coordinate values is described, but the present disclosure is not limited thereto. For example, the coordinate values of the definition points P11, P12, P21, P22, P31, P32, P41, P42 in a coordinate system that is different from the latitude-longitude coordinate system may be transformed to unique coordinate values. In a specific example, a coordinate system that is defined in aerial photography, for example, a pixel coordinate system of an aerial photograph image, can be used. In this example, a user specifies the coordinate values of the specific points P1, P2 in the pixel coordinate system (hereinafter, also referred to as “pixel coordinate values”) in the aerial photograph image, and measures the unique coordinate values of the specific points P1, P2 by using the radio wave sensor 10. The setting device 100 generates a transformation equation for transforming pixel coordinate values to unique coordinate values, based on the pixel coordinate values of the specific points P1, P2 and the unique coordinate values of the specific points P1, P2. The user specifies the pixel coordinate values of the definition points P11, P12, P21, P22, P31, P32, P41, P42 in the aerial photograph image, and inputs the specified pixel coordinate values to the setting device 100. The setting device 100 transforms the inputted pixel coordinate values of the definition points P11, P12, P21, P22, P31, P32, P41, P42, to unique coordinate values according to the transformation equation, and sets the detection areas 30A, 30B, 30C in the radio wave sensor 10, based on the unique coordinate values obtained through transformation.

In the above-described embodiment, the latitude-longitude coordinate values of the definition points P11, P12, P21, P22, P31, P32, P41, P42 are transformed to unique coordinate values by using the setting device 100 that is separate from the radio wave sensor 10, but the present disclosure is not limited thereto. For example, the radio wave sensor 10 is provided with the function of the setting device 100, and the radio wave sensor 10 may transform the latitude-longitude coordinate values of the definition points P11, P12, P21, P22, P31, P32, P41, P42 to unique coordinate values. Further, in this case, the radio wave sensor 10 may generate the transformation equation.

### [6. Additional Note]

The embodiment disclosed herein is merely illustrative in all aspects and should not be recognized as being restrictive. The scope of the present disclosure is defined by the scope of the claims rather than by the above embodiment, and is intended to include meaning equivalent to the scope of the claims and all modifications within the scope

### REFERENCE SIGNS LIST

10 radio wave sensor
20 crosswalk
30A, 30B, 30C detection area
40 radio-wave irradiation range
50 structure
51 pole
52 arm
100 setting device
101 processor
102 nonvolatile memory
103 volatile memory
104 input device
105 display device
106 communication interface (communication I/F)
107 setting program
110 input unit
111 reception unit
112 correction unit
113 generation unit
114 transformation unit
115 setting unit
300 reference object
P1, P2 specific point
P11, P12, P21, P22, P31, P32, P41, P42 definition point

1. A radio wave sensor setting method for setting, in a radio wave sensor, a detection area determined on a road, the radio wave sensor setting method comprising:
acquiring coordinate values, in a latitude-longitude coordinate system, of each of a plurality of definition points that define the detection area;
transforming the coordinate values of each of the plurality of definition points in the latitude-longitude coordinate system, to coordinate values in a unique coordinate system that is used in the radio wave sensor; and
setting the detection area in the radio wave sensor, based on the coordinate values of each of the plurality of definition points in the unique coordinate system.

2. The radio wave sensor setting method according to claim 1, further comprising generating a transformation equation for transforming coordinate values in the latitude-longitude coordinate system to coordinate values in the unique coordinate system, based on coordinate values of a plurality of points in the latitude-longitude coordinate system and coordinate values of the plurality of points in the unique coordinate system.

3. The radio wave sensor setting method according to claim 2, wherein the plurality of points used to generate the transformation equation are different from the plurality of definition points.

4. The radio wave sensor setting method according to claim 2, wherein the plurality of points used to generate the transformation equation include an origin in the unique coordinate system.

5. The radio wave sensor setting method according to claim 4, wherein the plurality of points used to generate the transformation equation further include a point on a coordinate axis, other than the origin, in the unique coordinate system.

6. The radio wave sensor setting method according to claim 5, wherein the coordinate axis extends along a reference line that is a line of intersection of the ground and a vertical plane including a radio-wave irradiation axis of the radio wave sensor.

7. The radio wave sensor setting method according to claim 2, further comprising:
acquiring the coordinate values, in the latitude-longitude coordinate system, of the plurality of points used to generate the transformation equation; and
acquiring the coordinate values, in the unique coordinate system, of the plurality of points used to generate the transformation equation through detection, by the radio wave sensor, of a reference object placed at each of the plurality of points used to generate the transformation equation.

8. The radio wave sensor setting method according to claim 7, wherein
in acquiring the coordinate values in the unique coordinate system, the coordinate values, in the unique coordinate system, of the plurality of points used to generate the transformation equation are acquired by correcting, based on a height of the radio wave sensor from the ground, a measured value of a distance to the reference object by the radio wave sensor.

9. The radio wave sensor setting method according to claim 7, wherein
in acquiring the coordinate values in the latitude-longitude coordinate system, before the radio wave sensor is activated, the coordinate values, in the latitude-longitude coordinate system, of the plurality of points used to generate the transformation equation are acquired.

10. A setting device for setting, in a radio wave sensor, a detection area determined on a road, the setting device comprising:
an input unit configured to receive coordinate values, in a latitude-longitude coordinate system, of each of a plurality of definition points that define the detection area;
a transformation unit configured to transform the coordinate values of each of the plurality of definition points in the latitude-longitude coordinate system, to coordinate values in a unique coordinate system that is used in the radio wave sensor; and
a setting unit configured to set the detection area in the radio wave sensor, based on the coordinate values of each of the plurality of definition points in the unique coordinate system.

11. A computer-readable non-transitory storage medium having stored therein a computer program for setting, in a radio wave sensor, a detection area determined on a road, the computer program causing a computer to:
acquire coordinate values, in a latitude-longitude coordinate system, of each of a plurality of definition points that define the detection area;
transform the coordinate values of each of the plurality of definition points in the latitude-longitude coordinate system, to coordinate values in a unique coordinate system that is used in the radio wave sensor; and
set the detection area in the radio wave sensor, based on the coordinate values of each of the plurality of definition points in the unique coordinate system.
